(19) United States
(12) Patent Application Publication
(10) Pub. No.: US 2004/0058836 A1
(43) Pub. Date: Mar. 25, 2004

(54) Acidic liquid peroxide bleach formulation

(76) Inventors: Chris Efstathios Housmekerides, Ludwigshafen (DE); Daniele Fregonese, Ludwigshafen (DE); Luca Zambelli, Venice (IT); Dora Zamuner, Venice (IT)

Correspondence Address: Norris McLaughlin & Marcus, 220 East 42nd Street, 30th Floor, New York, NY, 10017, US

(21) Appl. No.: 10/311,175

(22) PCT Filed: Jun. 8, 2001
(86) PCT No.: PCT/GB01/02509

(30) Foreign Application Priority Data
Jun. 16, 2000 (GB) 0014722.3

(51) Int. Cl. C11D 3/00

(52) U.S. Cl. 510/376; 510/446

(57) ABSTRACT

An acidic liquid peroxide bleach formulation for laundry comprising particles in stable suspension said particles comprising, as a core, at least one fatty acid and/or salt thereof, and a coating which is insoluble in the bleach formulation, but becomes rapidly soluble upon raising the pH of the environment-above about 7.

This invention relates to acid liquid peroxide bleach formulations for laundry. In particular, this invention relates to acidic liquid peroxide bleach formulations for laundry comprising particles in stable suspension.

Acidic liquid bleach formulations are well known as specific purpose laundry detergent products. Those products are generally used—as added to the usual laundry detergent—to enhance mainly the bleach activity. With the present products, there are, however, some problems, which have not been fully met as yet. One particular problem is the removal of chocolate/ice-cream soiling on fabrics.

Surprisingly, it has now been found that adding particles held in stable suspension in the formulation, which particles comprise at least one fatty acid which is only released when the formulation is added to the washing liquor, i.e. when the pH of the environment is raised above about 7, results in an improved performance in removing chocolate/ice-cream soiling both in pre-treated swatches as well as in wash cycles.

The invention is therefore related to an acidic liquid peroxide bleach formulation for laundry comprising particles in stable suspension said particles comprising, as a core, at least one fatty acid and/or salt thereof, and a coating which is insoluble in the bleach formulation, but becomes rapidly soluble upon raising the pH of the environment above about 7.

In a preferred embodiment the particles comprise at least stearic acid and/or a salt thereof.

In a specific embodiment of the present invention said coating comprises at least one copolymer of methacrylic acid and methacrylate.

The core may additionally comprise at least one substance denser than the fatty acid or its salts to adjust the density of the particles, preferably titanium dioxide.

Moreover, the invention is related to the use of particles as defined hereinabove to improve the performance of acidic liquid peroxide bleach formulations comprising such particles in removing chocolate/ice-cream soiling on fabrics.

As described in more detail later on, the formulations according to the present invention show distinctive performance improvements, compared to similar formulations with the same active ingredients, but not contained in coated particles, for removal of chocolate/ice-cream soils on fabrics.

Although we do not want to be bound by any theory, it is hypothesised that the coated form of the particles, and thus the delayed release of the fatty acid and/or salt thereof from the core, plays a relevant role in this performance improvement.

Appropriate pH sensitive coatings for particles in similar formulations are known from prior art. For example, EP 0 292 314 A1 discloses a process for coating particles with a pH sensitive latex insoluble in acidic environments and soluble in alkaline environments.

Although it is already mentioned to incorporate such particles, comprising bleaches, bleach precursor or activators, enzymes, colorants and/or surfactants, in liquid or gel compositions, there is no hint in this prior art document to any improved performance, in particular to the specific performance improvement shown in the present invention.

As it is preferred to obtain formulations having the particles held in suspension in homogenous distribution throughout the whole formulation, the density difference between the particles and rest of the formulation should be small, e.g. no more than ±0.2 g/cm³. To adjust the density of the particles, any filler could be added to the core. However, a raw material such as titanium dioxide would be preferred. Titanium dioxide would, at the same time, serve the additional purpose of increasing the whiteness of the particles to allow a better visibility thereof in the formulation to control the homogenous distribution of the particles in the formulation and for aesthetical reasons.

### EXAMPLE

Particles containing stearic acid are prepared as follows:

A mixture of 90 wt.-% stearic acid and 10 wt.-% TiO₂ (to adjust the density and increase the whiteness) are formed into spherical particles having a size in the range of about 0.2 to 1.5 mm in diameter; preferably, 0.5-0.8 mm.

Those particles are encapsulated by a coating consisting of a copolymer of methacrylic and methacrylate, such as copolymers of the Eudragit® series, e.g. Eudragit® S100, and a minor amount of a known plasticizer such as diisopropyl adipate.

The actual composition of the particles is reflected by the following table.

| Components | Particle composition [%] |
|---|---|
| Stearic Acid | 63.00 |
| TiO₂ | 7.00 |
| Eudragit S100 | 27.27 |
| Diisopropyl adipate | 2.73 |

The particles are incorporated in an acidic liquid bleach formulation E1 with the following composition:

| Component | E1 % |
|---|---|
| Hydrogen peroxide | 6.50 |
| Nonionic C12-15 + 5 EO | 7.00 |
| Polyacrylate | 0.20 |
| Perfume | 0.20 |
| Pigment | 0.001 |
| Water | ad 00 |
| Viscosity (cps) | 500-1500 |
| pH | 4.2 |

Performance Tests

30×30 cm pieces of white fabric were soiled with chocolate/ice-cream technical stains. Those soiled fabrics were washed in a Balay T8223 washing machine selecting a 60° C. washing program with a) commercial laundry detergent only, b) adding 100 ml of bleach formulation E1 without particles, c) adding 100 ml bleach formulation with 1 wt.-% particles according to the invention and d) adding of bleach formulation E1 plus 0.63 wt.-% stearic acid, 0.07 wt.-% TiO₂ and 0.3 wt.-% Eudragit® (as in the particle, however, not in the described particle form). The percentages given in.the following tables represent the reflectance of the sample, i.e. the higher the number, the better the cleaning performance.

| | (a) | (b) | (c) | (d) |
|---|---|---|---|---|
| Chocolate | 67.0 | 69.0 | 73.3 | 71.4 |
| Chocolate/ice- | 59.7 | 61.2 | 65.3 | 64.9 |
| cream | | | | |

The performance improvement is even more pronounced with a 60° C. pre-treatment and scrubbing, as shown in the following table:

| | (a) | (b) | (c) | (d) |
|---|---|---|---|---|
| Chocolate/ice- | 68.5 | 61.2 | 72.8 | 62.0 |
| cream | | | | |

The features disclosed in the foregoing description and in the claims may, both separately and in any combination thereof, be material for realising the invention in diverse forms thereof.

1. An acidic liquid peroxide bleach formulation for laundry comprising particles in stable suspension said particles comprising, as a core, at least one fatty acid and/or salt thereof, and a coating which is insoluble in the bleach formulation, but becomes rapidly soluble upon raising the pH of the environment above about 7.

2. The formulation according to claim 1, wherein the particles comprise at least stearic acid and/or a salt thereof.

3. The formulation according to claim 1 or 2, wherein said coating comprises at least one polymer whose solubility increases at increasing pH.

4. The formulation according to claim 3, wherein said coating comprises at least one copolymer of methacrylic acid and methacrylate.

5. The formulation according to any preceding claim, wherein the core additionally comprises at least one substance to adjust the density of the particles.

6. The formulation according to claim 5, wherein the particles additionally comprise titanium dioxide.

7. The use of particles as defined in one of the preceding claims to improve the performance of acidic liquid peroxide bleach formulations comprising such particles in removing chocolate/ice-cream soiling on fabrics.
